(19) United States
(12) Patent Application Publication
(10) Pub. No.: US 2006/0174779 A1
(43) Pub. Date: Aug. 10, 2006

(54) Coffee maker

(75) Inventor: Dicken Man Chiu NG, Hong Kong (CN)

Correspondence Address: LEYDIG VOIT & MAYER, LTD, 700 THIRTEENTH ST. NW, SUITE 300, WASHINGTON, DC, 20005-3960, US

(73) Assignee: Main Power Electrical Factory Ltd., Kwun Tong (HK)

(21) Appl. No.: 11/301,246

(22) Filed: Dec. 13, 2005

(30) Foreign Application Priority Data
Feb. 8, 2005 (GB) 0502430.2

(51) Int. Cl. A47J 43/14

(52) U.S. Cl. 99/495

(57) ABSTRACT

A coffee maker has a water reservoir, a water heater, a coffee holder for holding coffee grounds and a pump for pumping water from the reservoir through the heater to deliver pressurized water to the coffee holder. The coffee holder has a sieve holder and two exchangeable sieves including a first, drip-coffee, sieve and a second, espresso-coffee, sieve. The coffee maker can be used for preparing alternatively drip-coffee or espresso-coffee.

### BACKGROUND OF THE INVENTION

1. Field of the Invention

The invention relates to coffee makers and in particular to drip-coffee makers and to espresso-coffee makers.

2. Description of Prior Art

In a drip-coffee machine hot water is passed through coffee grounds at atmospheric pressure to infuse the water with coffee flavour. One disadvantage of this process is that typically it takes 15 minutes to make 8 cups of coffee. Espresso coffee, or express coffee, can be made much faster. In an espresso-coffee machine fine ground coffee is packed into a holder and pressurized water passed through the coffee at constant temperature and pressure. A cup of espresso coffee can be made in only a few seconds. Coffee made by the two processes has a different taste and aroma.

It would be desirable to have a coffee maker that could make alternatively drip-coffee or espresso-coffee. However, the size and expense of such a machine would be high because, for instance, two heating systems, deliver systems and coffee holders would be required.

### SUMMARY OF THE INVENTION

It is an object of the present invention to provide a coffee maker for preparing alternatively drip-coffee or espresso-coffee which overcomes or at least ameliorates the above disadvantages.

According to the invention there is provided a coffee maker for preparing alternatively drip-coffee or espresso-coffee comprising a water reservoir, a water heater, a coffee holder for holding coffee grounds and a pump for pumping water from the reservoir through the water heater to deliver pressurized hot water to the coffee holder, the coffee holder having a sieve holder and at least two exchangeable sieves including a drip-coffee sieve and a espresso-coffee sieve.

Preferably, the coffee maker further includes a third exchangeable pellet-coffee sieve.

Preferably, the pellet-coffee sieve has a shape for holding a coffee POD.

Preferably, the drip-coffee sieve comprises a course mesh and the espresso-coffee sieve comprises a fine mesh finer than the course mesh.

Preferably, the drip-coffee sieve comprises a course mesh for causing a first water pressure in the coffee holder and the espresso-coffee sieve comprises a finer mesh for alternatively causing a second water pressure higher than the first water pressure in the coffee holder.

Further aspects of the invention will become apparent from the following drawings and description.

### BRIEF DESCRIPTION OF THE DRAWINGS

Embodiments of the invention will now be described by way of example only and with reference to the accompanying drawings in which:

FIG. 1 is a schematic view of a coffee maker according to the invention, and

FIG. 2 is a diagrammatic view of the coffee maker.

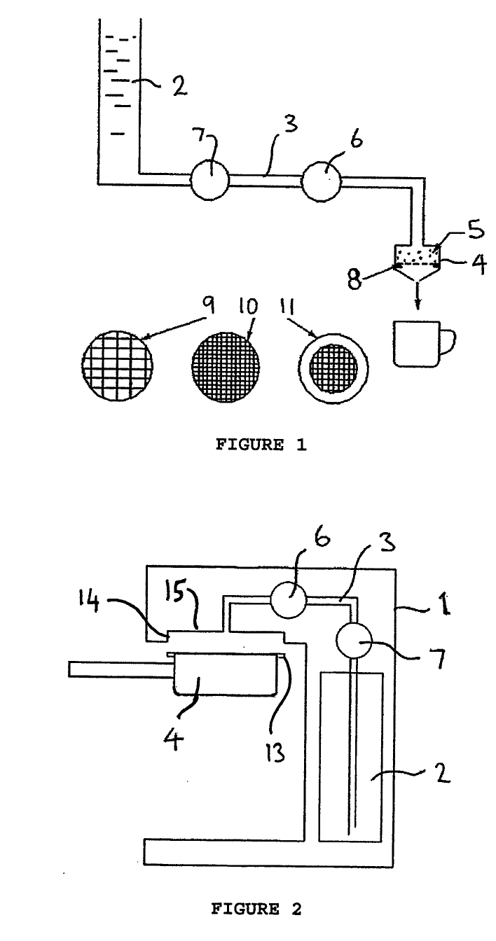

### DESCRIPTION OF THE PREFERRED EMBODIMENT

In the drawings there is depicted a coffee maker 1 for preparing alternatively drip-coffee or espresso-coffee. The coffee maker has a water reservoir 2 with a water outlet passage 3 extending to a coffee holder 5 for holding coffee grounds 5. In the passage 3 are a water heater 6 and a pump 7 for pumping water from the reservoir 2 through the heater 6 to deliver pressurized hot water to the coffee holder 4 at a brew head 15. The outlet water pressure is typically 15 Bar.

The coffee holder 4 is similar to portafilters known in that art. It has a bayonet-type twist-and-lock connection 13 that aligns to mate with a flange 14 at lower part of the brew head 15 and is rotated, or twisted, to lock and seal the sieve holder 4 to the brew head 15 tightly before brewing starts.

Within the coffee holder 4 is a projecting edge 8 for holding exchangeable disc-shaped sieves 9, 10, 11 having various mesh sizes designed to create different backpressure of hot water in the coffee holder 4.

A first course sieve 9 has a large mesh size to reduce the outlet water pressure in the coffee holder 4 to just above atmospheric pressure (1 Bar). This sieve is suitable for holding course ground coffee for making drip-coffee. The brew time of drip-coffee is substantially reduced with the coffee maker.

A second sieve 10 has a fine mesh size to create water pressure higher than the first sieve 9 in the coffee holder. This sieve is suitable to holding fine ground coffee for making espresso-coffee.

A third sieve 11 has a finer mesh like second sieve 10, but has a smaller mesh area to create steam pressure higher than that of second sieve 10 in the coffee holder. Third sieve 11 has a shape for holding a-coffee POD for making espresso-coffee. A Coffee POD is a filter paper sachet containing fine ground coffee.

The coffee maker has a single heater and water pump system but through the use of exchangeable sieves can be used to make alternatively drip-coffee or espresso-coffee.

Where in the foregoing description reference has been made to integers or elements having known equivalents then such are included as if individually set forth herein.

Embodiments of the invention have been described, however it is understood that variations, improvement or modifications can take place without departure from the spirit of the invention or scope of the appended claims.

1. A coffee maker for preparing, alternatively, drip-coffee or espresso-coffee comprising a water reservoir, a water heater, a coffee holder for holding coffee grounds, and a pump for pumping water from the reservoir through the water heater to deliver pressurized hot water to the coffee holder, the coffee holder having a sieve holder and at least two exchangeable sieves including a drip-coffee sieve and a espresso-coffee sieve.

2. The coffee maker of claim 1 further including a third exchangeable pellet-coffee sieve.

3. The coffee maker of claim 2 wherein the pellet-coffee sieve has a shape for holding a coffee POD.

4. The coffee maker of claim 1 wherein the drip-coffee sieve comprises coarse mesh and the espresso-coffee sieve comprises a fine mesh finer than the coarse mesh.

5. The coffee maker of claim 1 wherein the drip-coffee sieve comprises mesh for causing a first water pressure in the coffee holder and the espresso-coffee sieve comprises a finer mesh for causing a second water pressure, higher than the first water pressure, in the coffee holder.

6. A coffee maker for preparing, alternatively, drip-coffee or espresso-coffee comprising a water reservoir, a water heater, a coffee holder for holding coffee grounds, and a pump for pumping water from the reservoir through the heater to deliver pressurized water to the coffee holder, the coffee holder having a sieve holder and at least two exchangeable sieves including a first sieve for causing a first water pressure in the coffee holder and a second sieve for creating a second water pressure, higher than the first water pressures in the coffee holder.

7. The coffee maker of claim 6 wherein the coffee holder includes a third sieve for creating a third water pressures higher than the second water pressures in the coffee holder.
